(19) United States
(12) Patent Application Publication
(10) Pub. No.: US 2016/0085815 A1
(43) Pub. Date: Mar. 24, 2016

(54) INFORMATION PROCESSING APPARATUS, INFORMATION PROCESSING METHOD, AND STORAGE MEDIUM

(71) Applicant: YAHOO JAPAN CORPORATION, Tokyo (JP)

(72) Inventors: Takayuki TSUCHIYA, Tokyo (JP); Hidehito GOMI, Tokyo (JP); Hiroshi OTA, Tokyo (JP); Takashi ANDO, Tokyo (JP)

(21) Appl. No.: 14/853,239

(22) Filed: Sep. 14, 2015

(30) Foreign Application Priority Data
Sep. 19, 2014 (JP) 2014-190686

(51) Int. Cl. G06F 17/30

(52) U.S. Cl. CPC G06F 17/30528; G06F 17/30477; G06F 17/30554

(57) ABSTRACT

An information processing apparatus according to an embodiment includes an information acquisition unit, a user information extraction unit, and a grouping processing unit. The information acquisition unit acquires information on an identification target provided in a place corresponding to a business operator from a user terminal that detects the information on the identification target. The user information extraction unit, when the information on the identification target is acquired by the information acquisition unit, extracts from the business operator information database user information corresponding to the user terminal among pieces of user information of the business operator corresponding to the place in which the identification target is provided. The grouping processing unit assigns the user terminal to one or more groups based on the user information extracted by the user information extraction unit.

### CROSS-REFERENCE TO RELATED APPLICATION

The present application claims priority to and incorporates by reference the entire contents of Japanese Patent Application No. 2014-190686 filed in Japan on Sep. 19, 2014.

### BACKGROUND OF THE INVENTION

1. Field of the Invention

The present invention relates to an information processing apparatus, an information processing method, and a storage medium.

2. Description of the Related Art

Along with recent rapid spread of networks such as Internet, information provision over networks is actively conducted. For example, there is known an information provision system that detects a radio terminal existing in a communication area of a radio communication device and notifies the radio terminal of information corresponding to the radio communication device (see, for example, Japanese Patent Application Laid-open No. 2014-112751).

Conventional information provision systems can provide information in accordance with a place corresponding to a business operator. And now, it is desirable to perform adequate control in accordance with user information corresponding to a user terminal. Further, it is desirable to provide a predetermined new service to a user terminal as provision of information.

### SUMMARY OF THE INVENTION

An information processing apparatus according to an embodiment includes a business operator information database, an information acquisition unit, a user information extraction unit, and a grouping processing unit. The business operator information database stores pieces of user information of a business operator. The information acquisition unit acquires information on an identification target provided in a place corresponding to the business operator from a user terminal that detects the information on the identification target. The user information extraction unit extracts, when the information on the identification target is acquired by the information acquisition unit, from the business operator information database user information corresponding to the user terminal among the pieces of user information of the business operator corresponding to the place in which the identification target is provided. The grouping processing unit assigns the user terminal to one or more groups based on the user information extracted by the user information extraction unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1A is an illustrative diagram (No. 1) of information processing according to an embodiment;

FIG. 1B is an illustrative diagram (No. 2) of the information processing according to the embodiment;

FIG. 2 is a diagram illustrating a specific configuration example of an information processing system according to the embodiment;

FIG. 3 is a diagram illustrating a configuration example of a user terminal according to the embodiment;

FIG. 4 is a diagram illustrating a configuration example of an information processing apparatus according to the embodiment;

FIG. 5 is a diagram illustrating an example of a partner user information table;

FIG. 6 is a diagram illustrating an example of a partner company information table;

FIG. 7 is a diagram illustrating an example of an associated information table;

FIG. 8 is a diagram illustrating an example of a group setting information table;

FIG. 9 is a diagram illustrating an example of a group condition information table;

FIG. 10 is a flowchart illustrating an example of information processing of the user terminal according to the embodiment;

FIG. 11 is a flowchart illustrating information processing of the information processing apparatus according to the embodiment; and

FIG. 12 is a hardware configuration diagram illustrating an example of a computer that realizes functions of the image processing apparatus.

### DETAILED DESCRIPTION OF THE PREFERRED EMBODIMENT

Hereinafter, an embodiment of an information processing apparatus, an information processing method, and a storage medium according to the present application will be described in detail with reference to the drawings; however, the information processing apparatus, the information processing method, and the storage medium according to the present application are not limited to the following embodiment. Hereinafter, a database is referred to as DB.

### 1. INFORMATION PROCESSING

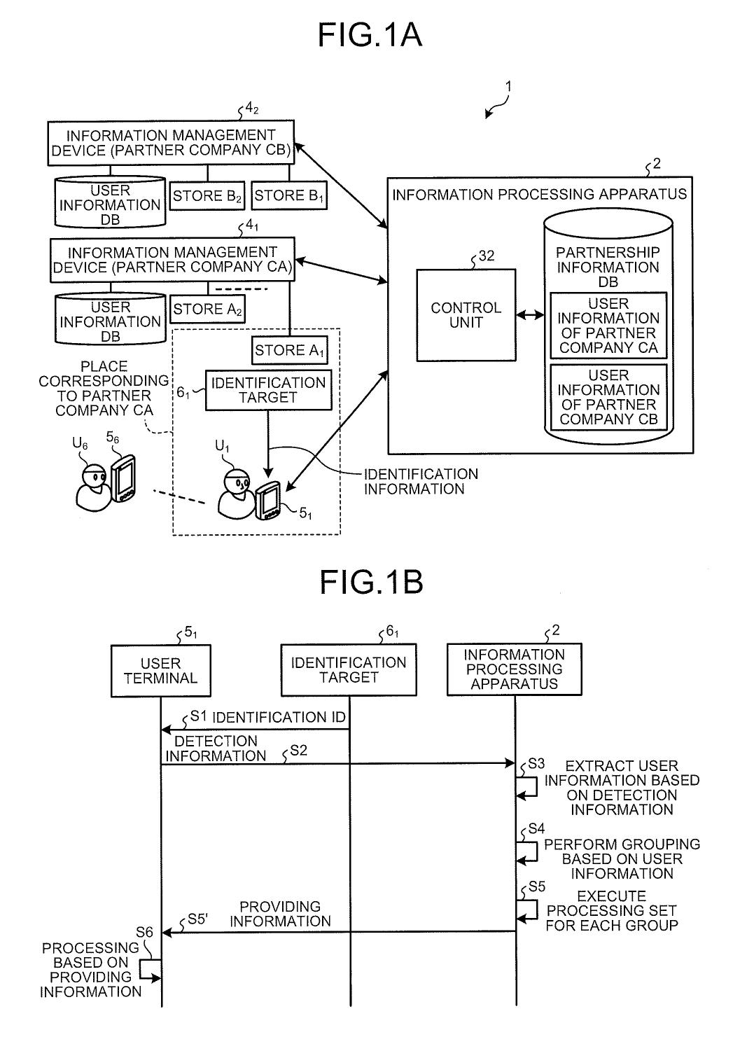

First, information processing according to an embodiment will be described. FIGS. 1A and 1B are illustrative diagrams of information processing according the embodiment. In the present embodiment, the information processing is executed by an information processing system.

As illustrated in FIG. 1A, an information processing system 1 includes an information processing apparatus 2 and information management devices 4₁ and 4₂. The information processing apparatus 2 is managed and operated by, e.g., a service provider. The information management devices 4₁ and 4₂ (hereinafter, sometimes referred to collectively as an information management device 4) are managed and operated by partner companies CA and CB (hereinafter, sometimes referred to collectively as a partner company C), respectively.

User terminals 5₁ to 5₆ illustrated in FIG. 1A are user terminals owned by users U₁ to U₆ who come to a store or facility (hereinafter, referred to collectively as a store) of the partner company C or purchase goods or services in the store of the partner company C. Hereinafter, the user terminals 5₁ to 5₆ are sometimes referred to collectively as a user terminal 5, and the users U₁ to U₆ are sometimes referred to collectively as a user U. The store or facility of the partner company C can be translated as a business place of the partner company C.

The partner company C is a business operator who has signed a partnership contract with the service provider and is, e.g., a business operator who provides goods or services. The partner company CA is a business operator who provides goods or services at stores A₁ and A₂. The partner company CB is a business operator who provides events such as a seminar at stores B₁ and B₂. The event mentioned above may be a class of a private tutoring school, a class of a school, a tour, a concert, or a sports event. The partner company C may be a company that operates a commercial space such as a hotel, a beauty parlor/barbershop, a hospital, a movie theater, or a combined leisure facility.

The information management device 4₁ has a user information DB that stores user information possessed by the partner company CA, and the information management device 4₂ has a user information DB that stores user information possessed by the partner company CB. The information processing apparatus 2 acquires the user information of the partner companies CA and CB from the information management devices 4₁ and 4₂ and stores the acquired user information in a partnership information DB (an example of a business operator information DB).

The user information stored in the user information DB of the information management device 4 includes, e.g., attribute information of the user U, behavior history information of the user U, and identification information of the user terminal 5 (hereinafter, referred to as a terminal ID). The attribute information of the user U includes, e.g., demographic attributes such as gender, age, address of the user U and psychographic attributes such as preference of the user U. The behavior history information includes an online behavior history of the user U and an offline behavior history of the user U. For example, the behavior history includes a visit history or a purchase history of the user U to/in the store of the partner company C, information of an event for which the user U has applied, and the like.

An identification target is provided in a place corresponding to the partner company C. For example, an identification target 6₁ is provided in the store A₁ illustrated in FIG. 1A. Further, although not illustrated, identification targets 6₂, 6₃, and 6₄ are provided in the stores A₂, B₁, and B₂, respectively. Hereinafter, the identification targets 6₁ to 6₄ are sometimes referred to collectively as an identification target 6.

Examples of the identification target 6 include, e.g., a wireless communication device that performs communication such as a wireless LAN (Local Area Network), an NFC (Near Field Communication), or a Bluetooth® and one- or two-dimensional barcode (hereinafter, sometimes referred to merely as a barcode).

The user terminal 5 detects identification information (hereinafter, referred to as an identification target ID) on the identification target 6 and transmits the detected identification target ID to the information processing apparatus 2. For example, when the identification target 6 is the wireless communication device, the user terminal 5 detects the identification target ID transmitted thereto from the wireless communication device and transmits the detected identification target ID to the information processing apparatus 2. Further, when the identification target 6 is the barcode, the user terminal 5 converts the barcode photographed by using a photographing unit into text information, detects a part of or the entire text information as the identification target ID, and transmits the detected identification target ID to the information processing apparatus 2.

When receiving the identification target ID on the identification target 6 from the user terminal 5, a control unit 32 of the information processing apparatus 2 refers to a partnership information DB to extract the user information corresponding to the user terminal 5 that has transmitted the identification target ID from among pieces of the user information of the partner company C according to a place corresponding to the identification target ID. Hereinafter, the place corresponding to the identification target ID is sometimes referred to as a user entering place, and the user U of the user terminal 5 that has transmitted the identification target ID of the identification target 6 is sometimes referred to as an entering user U.

The control unit 32 assigns the user terminal 5 to one or more groups based on the extracted user information. For example, when the user entering place is a store of a business operator who provides goods or services, the control unit 32 assigns, to the user terminal 5, a group where the user attribute or behavior attribute included in pieces of the user information corresponding to the user terminal 5 is the same among members. For example, the control unit 32 determines that the user attribute is the same when similarity of the user attribute set for each group is equal to or higher than a predetermined threshold.

When the user entering place is an event site, the control unit 32 assigns, to the user terminal 5, a group where an event for which application is made included in pieces of the user information corresponding to the user terminal 5 is the same among the members. As a result, the user U who enters the event site is assigned to the same group as the other users U who participate in this event.

The control unit 32 executes a process set for each the group assigned to the user terminal 5. The process set for each the group includes, e.g., information providing processing or service providing processing. The control unit 32 provides, to the user U of the user terminal 5, services or information according to the group assigned thereto, thereby making it possible to provide services or information not only according to a place corresponding to the business operator, but also according to the user information.

The service providing processing is, e.g., application processing of a point program or community group formation processing. For example, assume that the user entering place is a store that provides goods or services. In this case, visit points or purchase points are given by the point program according to the assigned group. For example, the control unit 32 can give the visit points to an entering user U of a first group according to a first point program and can give the visit points to an entering user U of a second group according to a second point program.

As described above, the point program can be provided to the entering users U for each group assigned thereto based on the user information, so that the point service can have high customer attracting power.

Further, assume that the user entering place is an event site. In this case, the control unit 32 assigns a group ID according to the assigned group to the user terminal 5 of the entering user U. The group ID is identification information of, e.g., a community group where a message is exchanged between the user terminals 5.

The user terminal 5 has a function of transmitting/receiving a message and can thus exchange the message with other user terminals 5 within a network community formed for each group ID. The group ID-based community is formed through, e.g., a network bulletin board or an instant messenger. The instant messenger may have a function of deleting a message itself and data such as an image or voice added to the message after elapse of a predetermined time after confirmation of the message.

Further, the control unit 32 can assign, to the user terminal 5, a group whose members have, e.g., the same psychographic attribute (e.g., preference of the user U) of the user U. Also in this case, the control unit 32 can assign, to the user terminal 5 of the entering user U, the identification information of a community group according to the assigned group.

As described above, when the entering user U enters the place where the identification information on the identification target 6 is provided, he or she can participate in a network community formed between the user terminals 5 of the users U having the same user information. Thus, for example, only by entering an event site, event participants can easily participate in the community to thereby get a chance of new communication. Further, a plurality of users U having the same psychographic attribute can easily participate in the community only by entering a place where the identification information on the identification target 6 is provided to thereby get a chance of new communication.

The control unit 32 can assign, as the identification information of the community group, identification information of a temporary community group to the user terminal 5. For example, when the user entering place is an event site, the control unit 32 can assign, to the user terminal 5, identification information of a community group which is valid only during the event or only on a date of the event.

The information providing processing is, e.g., transmission processing of content or recommend information. The control unit 32 can distribute content according to the group to the user terminal 5 of the entering user U. For example, when the user entering place is a private tutoring school or a seminar venue, the control unit 32 distributes, to the user terminal 5 of the entering user U, e.g., a resume of a lecture or other materials. This can save time and trouble for a business operator to print or distribute the resume and the like. Further, the control unit 32 can distribute moving image content generated by acquiring in real time a lecturer's lecture to the user terminal 5 of the entering user U.

As described above, the control unit 32 of the information processing apparatus 2 divides the entering users U into groups based on the user information corresponding to the entering user U among pieces of the user information of the business operator corresponding to the user entering place and provides a different service or different information for each group. As a result, it is possible to provide, to the entering user U, adequate services or adequate information according to the user entering place.

The processing in which the control unit 32 assigns the user terminal 5 to one or more groups can be said to be processing of assigning the user U of the user terminal 5 to one or more groups, and thus the user U of the user terminal 5 may be assigned to one or more groups. This is because assigning the user U of the user terminal 5 to one or more groups results in assignment of the user terminal 5 to one or more groups.

The following describes an example of processing to be performed when the user U₁ of the user terminal 5₁ visits the store A₁ with reference to FIG. 1B.

When the user U₁ of the user terminal 5₁ visits the store A₁, the user terminal 5₁ acquires the identification target ID of the identification target 6₁ from the identification target 6₁ installed in the store A₁ (step S1). The user terminal 5₁ transmits detection information including the acquired identification target ID of the identification target 6₁ and terminal ID of the user terminal 5₁ itself to the information processing apparatus 2 over a communication network (step S2).

Upon acquiring the detection information from the user terminal 5₁, the control unit 32 of the information processing apparatus 2 refers to the partnership information DB to extract the user information corresponding to the terminal ID included in the detection information from among pieces of the user information of the partner company CA corresponding to the identification target ID included in the detection information (step S3).

Further, the control unit 32 assigns the user terminal 5₁ that has transmitted the detection information based on the user information extracted from the partnership information DB to one or more groups (step S4). For example, the control unit 32 assigns a group whose members have the same user information as the user terminal 5₁ to the user terminal 5₁.

The control unit 32 executes a process set for each the group assigned to the user terminal 5₁ (step S5 and S5′). For example, the user terminal 5₁ receives providing information from the information processing apparatus 2 through processing of step S5 and S5′ and performs processing according to the providing information (step S6).

For example, when the process set for each the group is community group formation processing, the control unit 32 assigns the group ID set for each group to the user terminal 5₁ and transmits the assigned group ID to the corresponding user terminal 5₁ as the providing information. Based on the group ID received from the information processing apparatus 2, the user terminal 5₁ exchanges a message within a community group corresponding to the group ID.

When the process set for each the group is transmission processing of content or recommended information, the control unit 32 transmits content or recommended information for each group to the user terminal 5₁ corresponding to the assigned group ID as the providing information. The user terminal 5₁ displays the content or recommend information received from the information processing apparatus 2.

### 2. CONFIGURATION OF INFORMATION PROCESSING SYSTEM

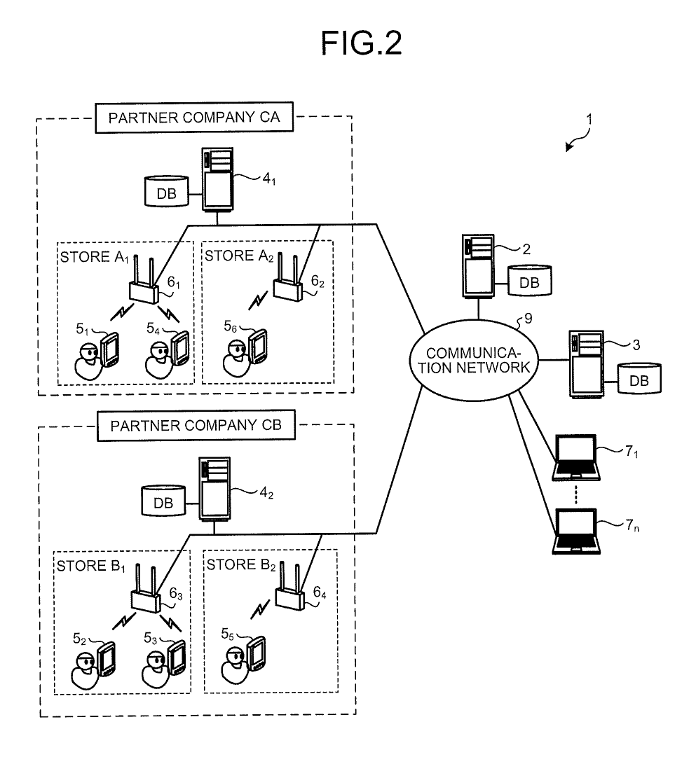

With reference to FIG. 2, a configuration example of the information processing system 1 according to the embodiment will be described. FIG. 2 is a diagram illustrating a specific configuration example of the information processing system 1 according to the embodiment.

As illustrated in FIG. 2, the information processing system 1 includes an information processing apparatus 2, a communication server 3, information management devices 4₁ and 4₂, user terminals 5₁ to 5₆, identification targets 6₁ to 6₄, and bidder terminals 7₁ to 7ₙ (sometimes referred to collectively as a bidder terminal 7).

The information processing apparatus 2, the communication server 3, the information management devices 4₁ and 4₂, the user terminals 5₁ to 5₆, and the bidder terminals 7₁ to 7ₙ are communicably connected to one another over a communication network 9. The communication network 9 is, e.g., a WAN (Wide Area Network) such as Internet.

In the example of FIG. 2, two partner companies CA and CB are illustrated; however, the number of the partner companies C may be one or three or more. One or more identification targets 6 are installed for each store of the partner company C. In the example of FIG. 2, the identification targets 6₁ and 6₂ are installed in the stores A₁ and A₂ of the partner company CA, respectively, and the identification targets 6₃ and 6₄ are installed in the stores B₁ and B₂ of the partner company CB, respectively.

The user terminal 5 is a terminal device having, e.g., a wireless WAN communication function, such as a smartphone or a PC (Personal Computer) and can communicate with a wireless WAN base station (not illustrated). The wireless WAN base station is connected to the communication network 9. The user terminal 5 may be connected to the communication network 9 not by radio but via a cable.

The identification target 6 may be a communication device that performs communication such as a wireless LAN, an NFC, or a Bluetooth® and a marker such as a barcode or a predetermined mark. The NFC has a coverage of about 1 m to several cm. For example, Felica, ISO/IEC14443 (MIFARE), and the like can be taken as an example of the NFC.

The identification target 6 may perform not only radio wave communication, but also infrared-ray communication, visible light communication, sound wave communication, human body communication, and wired communication. As an example of the human body communication, a BAN (Body Area Network) is known. The identification target 6 may not be connected to the communication network 9, and the connection configuration thereof is not limited to the example illustrated in FIG. 2.

The communication server 3 is a server that relays transmission/reception of a message between the user terminals 5. A control unit of the communication server 3 transmits a message transmitted from the user terminal 5 to another user terminal 5 having the same group ID as that of the user terminal 5 that has transmitted the message.

Configurations of the respective user terminal 5 and information processing apparatus 2 will be described below in this order.

### 3. USER TERMINAL

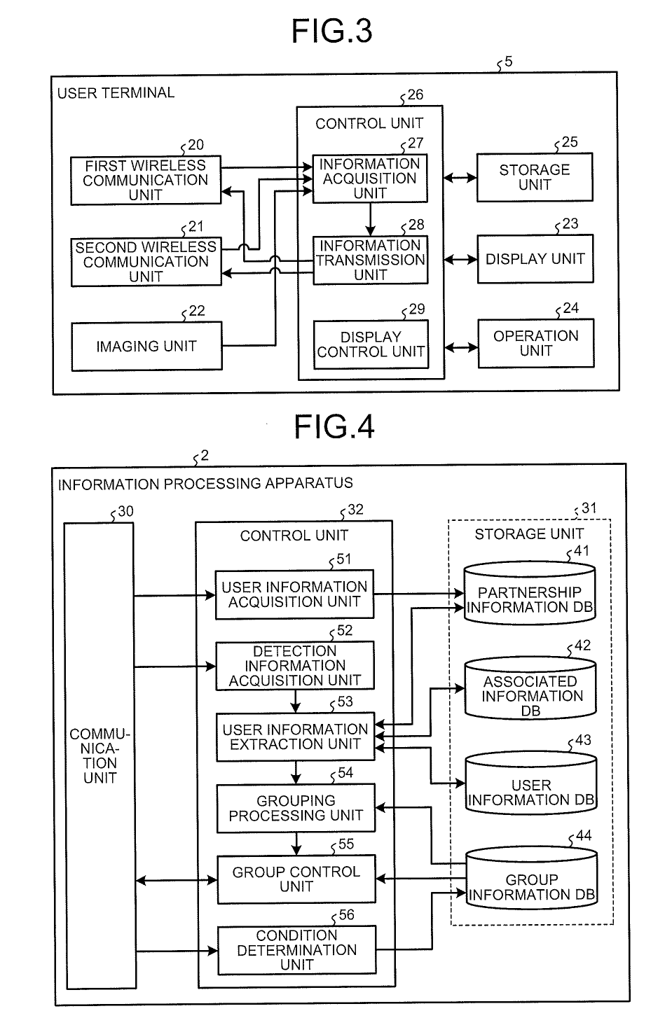

First, a configuration of the user terminal 5 will be described. FIG. 3 is a diagram illustrating a configuration example of the user terminal 5. As illustrated in FIG. 3, the user terminal 5 includes a first wireless communication unit 20, a second wireless communication unit 21, an imaging unit 22, a display unit 23, an operation unit 24, a storage unit 25, and a control unit 26.

The first wireless communication unit 20 is a communication interface that exchanges information with the identification target 6. The second wireless communication unit 21 is a communication interface that exchanges information with a wireless WAN base station (not illustrated). The wireless WAN base station is, e.g., a wireless base station for a public telephone communication network or a wireless base station for a public data communication network.

The imaging unit 22 has a CCD (Charge Coupled Devices) image sensor, a CMOS (Complementary MOS) image sensor, and the like. The imaging unit 22 photographs a surrounding area of the user terminal 5 and outputs data of the photographed image to the control unit 26.

The display unit 23 is a touch panel display. The user U of the user terminal 5 can perform operation to an operation screen displayed on the display unit 23 by touching the operation screen of the display unit 23 with his or her finger. The display unit 23 is, e.g., a small LCD (Liquid Crystal Display) or a small organic EL display.

The operation unit 24 has a keyboard including keys for inputting characters, numerals, or spaces, enter keys, and arrow keys, a power button, and the like.

The storage unit 25 is a storage device such as a hard disk or a semiconductor memory device such as a RAM (Random Access Memory) or a flash memory. The storage unit 25 stores therein various programs. The program to be stored in the storage unit 25 is e.g., an OS (Operating System), an application program acquired from the information processing apparatus 2, and the like.

The user terminal 5 has a not illustrated reading device, and the control unit 26 can read the application program recorded in a recording medium via the reading device and store the read application program in the storage unit 25. Examples of the recording medium include an optical disk, a flexible disk, a hard disk, and the like.

The control unit 26 is realized by an integrated circuit such as an ASIC or an FPGA. Information processing function and operation (to be described later) of the control unit 26 are realized or executed when, for example, a CPU or an MPU executes the program stored in the storage unit 25 using a not illustrated internal RAM as a working area.

Specifically, the control unit 26 executes the application program stored in the storage unit 25 to function as an information acquisition unit 27, an information transmission unit 28, and a display control unit 29. The configuration of the control unit 26 is not limited to the above-described configuration, but may have any configuration as long as it can perform information processing to be described later.

The information acquisition unit 27 acquires the identification target ID of the identification target 6. Specifically, the information acquisition unit 27 acquires the identification information on the identification target 6 output from the identification target 6 via the first wireless communication unit 20.

When the identification target 6 is a wireless LAN access point, the identification target ID of the identification target 6 is, e.g., an ESS-ID (Extended Service Set Identifier) or a BSS-ID (Basic Service Set Identifier) of the wireless LAN access point. When the identification target 6 is a device that performs Bluetooth® communication, the identification target ID of the identification target 6 is, e.g., a UUID (Universally Unique Identifier). When the identification target 6 is an NFC device, the identification target ID of the identification target 6 is, e.g., an ID of the NFC device.

When the identification target 6 is a barcode, the information acquisition unit 27 converts photographed image data of the barcode output from the imaging unit 22 into text information and acquires the text information as the identification target ID of the identification target 6. The information acquisition unit 27 can use predetermined image information (e.g., entire or a part of the photographed image of the identification target 6) identified from the photographed image of the identification target 6 as the identification target ID of the identification target 6.

The information acquisition unit 27 acquires the providing information transmitted from the information processing apparatus 2 in response to transmission of the detection information by the information transmission unit 28 and a message transmitted from the communication server 3 and stores them in the storage unit 25.

The information transmission unit 28 transmits the detection information including the identification target ID acquired by the information acquisition unit 27 and terminal ID stored in the storage unit 25 to the information processing apparatus 2 via the first or second wireless communication unit 20 or 21. When the identification target 6 is a wireless communication device, the detection information includes information of a radio wave intensity. The radio wave intensity is a radio wave intensity of a radio signal that the first wireless communication unit 20 receives from the identification target 6.

The information transmission unit 28 transmits a message (e.g., an instant message) input through an operation of the user U (hereinafter, referred to as a user operation) to the operation unit 24 to the communication server 3 via the first or second wireless communication unit 20 or 21.

The display control unit 29 displays a message (e.g., an instant message) input through a user operation or providing information or message stored in the storage unit 25 on the display unit 23. The providing information to be displayed on the display unit 23 is content or recommend information.

The information acquisition unit 27, the information transmission unit 28, and the display control unit 29 can exchange a message with the communication server 3 by using the group ID. For example, when the user U selects the group ID and inputs a message, the information transmission unit 28 transmits the group ID and message to the communication server 3. Further, when the information acquisition unit 27 acquires the group ID and message from the communication server 3, the display control unit 29 displays the message on a screen corresponding to the group ID.

### 4. INFORMATION PROCESSING APPARATUS

The following concretely describes a configuration of the information processing apparatus 2. FIG. 4 is a diagram illustrating a configuration example of the information processing apparatus 2. As illustrated in FIG. 4, the information processing apparatus 2 includes a communication unit 30, a storage unit 31, and a control unit 32.

The storage unit 31 includes a partnership information DB 41 (example of business operator information DB), an associated information DB 42, a user information DB 43, and a group information DB 44. The control unit 32 includes a user information acquisition unit 51, a detection information acquisition unit 52, a user information extraction unit 53, a grouping processing unit 54, a group control unit 55, and a condition determination unit 56.

The communication unit 30 is an interface such as an NIC (Network Interface Card). The control unit 32 exchanges various information with the communication server 3, the information management device 4, the user terminal 5, and the bidder terminal 7 via the communication unit 30 and communication network 9.

The partnership information DB 41, the associated information DB 42, the user information DB 43, and the group information DB 44 are each, e.g., a storage device such as a hard disk or a semiconductor memory device such as a RAM or a flash memory. The partnership information DB 41, the associated information DB 42, the user information DB 43, and the group information DB 44 may be embodied in one database.

In the control unit 32, an internal CPU or a MPU executes a program stored in an internal storage unit using a RAM as a working area. This allows the control unit 32 to function as the user information acquisition unit 51, the detection information acquisition unit 52, the user information extraction unit 53, the grouping processing unit 54, the group control unit 55, and the condition determination unit 56. The configuration of the control unit 32 is not limited to the above-described configuration, but may have any configuration as long as it can perform information processing to be described later.

4.1 User Information Acquisition Unit

The user information acquisition unit 51 acquires the user information possessed by the partner companies CA and CB from the information management devices 4₁ and 4₂, respectively, and stores the acquired user information in the partnership information DB 41. The user information is sequentially updated in the partner company C, and the user information acquisition unit 51 acquires the latest user information to update the user information in the partnership information DB 41.

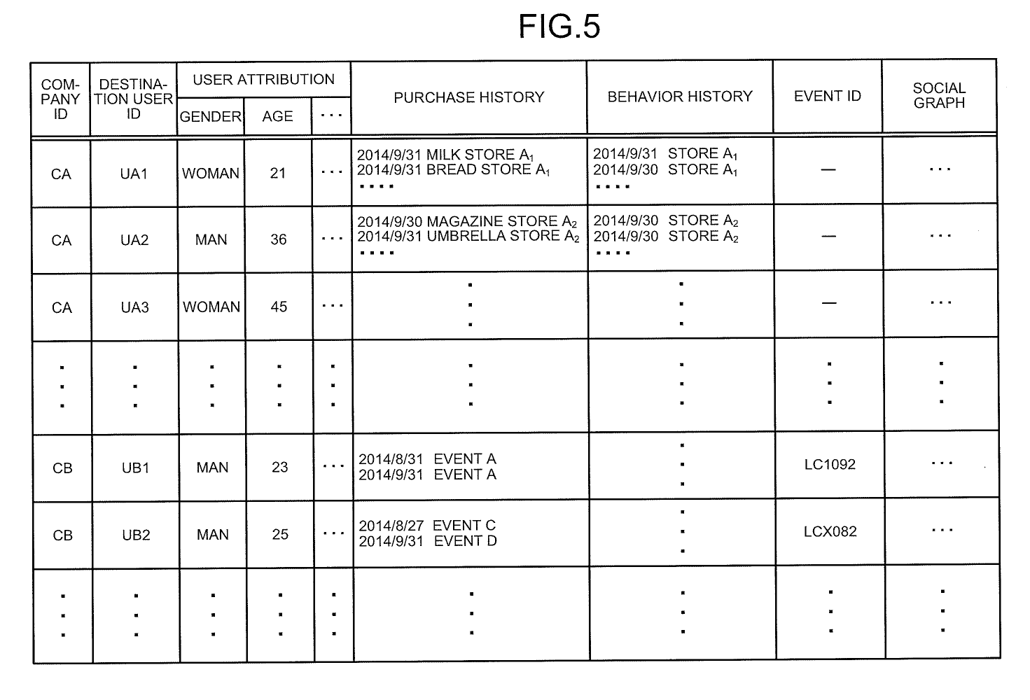

FIG. 5 is a diagram illustrating an example of a partner user information table stored in the partnership information DB 41. As illustrated in FIG. 5, the partner user information table is an information table in which information such as “company ID”, “destination user ID”, “user attribute”, “purchase history”, “behavior history”, “event ID”, and “social graph” are associated with one another.

The “company ID” is identification information of the partner company C. In the example of FIG. 5, “CA” is a company ID of the partner company CA, and “CB” is a company ID of the partner company CB. Although the user information of the partner company CA and user information of the partner company CB are set in the same partner user information table in the example of FIG. 5, the partner user information table and partnership information DB 41 may be provided for each partner company C. This allows the user information to be managed for each partner company C.

The “destination user ID” is a user ID uniquely set for each partner company C and is assigned to the user U who uses the partner company C. In the example of FIG. 5, user IDs “UA1”, “UA2”, and the like are assigned to the users U of the partner company CA, and user IDs “UB1” and the like are assigned to the users U of the partner company CB. A set of the company ID and destination user ID only needs to be uniquely identified, and the destination user ID of the partner company CA and destination user ID of the partner company CB may be an overlapping ID.

The “user attribute” indicates an attribute of the user U and includes, e.g., demographic attributes and psychographic attributes. The demographic attribute is a demographic-based attribute of the user U and includes attributes such as gender and age of the user U. The demographic attribute may include attributes such as address, occupation, family structure, annual income, birthplace, and educational background of the user U.

The psychographic attribute is information indicating values, lifestyle, character, preference, and the like of the user U. The psychographic attribute is set in the partner user information table for each partner company C or for each store based on the purchase history or behavior of the user U in the store of the partner company C.

The “purchase history” is a purchase history of the user U in the store of the partner company C. For example, as illustrated in FIG. 5, the purchase history includes information such as a purchase date, a purchased article (including a manufacturer name and an article name), and a purchase store. The “behavior history” is a behavior history of the user U with respect to the store of the partner company C. For example, as illustrated in FIG. 5, the behavior history is a visit history of the user U to the store of the partner company C. The visit history includes information such as a visit date and a visit store.

The “event ID” is identification information of the event for which the user U has applied. Examples of the event include, e.g., a seminar, a course, a speech or lecture, a marriage meeting, a party, a tour, a golf competition, a concert, and a sports game watching, and the event ID is assigned for each event. When one event is held several times, different event IDs are correspondingly assigned. Although, in the example of FIG. 5, the “behavior history” and “event ID” are separately set for descriptive convenience, the “event ID” may be included in the “behavior history” since it is included in the behavior history of the user.

In the example of FIG. 5, the partner company CB is a business operator who holds an event and, for example, the user U of the destination user ID “UB1” has applied for an event corresponding to an event ID “LC1092”. Of all the events for which the user U has applied, the event that has already been ended is deleted from the partner user information table by the control unit 32.

The “social graph” is information identifying a user U having a social connection with another user U. Specifically, for example, the social graph is information identifying a user U having an acquaintance relationship with another user U. The social graph can be acquired from a not illustrated server by the control unit 32.

4.2 Detection Information Acquisition Unit

The detection information acquisition unit 52 acquires the detection information transmitted from the user terminal 5 and outputs the acquired detection information to the user information extraction unit 53. Further, the detection information acquisition unit 52 updates the behavior history in the partner user information table based on the detection information transmitted from the user terminal 5.

4.3 User Information Extraction Unit

The user information extraction unit 53 refers to the partner user information table stored in the partnership information DB 41 to extract the user information corresponding to the terminal ID included in the detection information from among pieces of the user information of a business operator corresponding to the identification target ID included in the detection information.

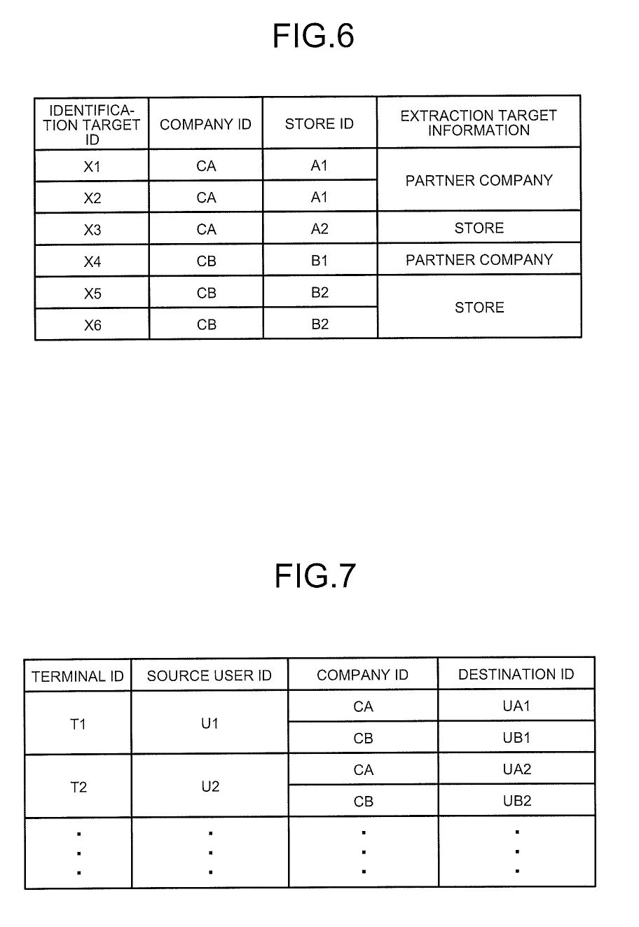

For example, the user information extraction unit 53 identifies the user information of the business operator corresponding to the identification target ID based on a partner company information table. FIG. 6 is a diagram illustrating an example of the partner company information table. As illustrated in FIG. 6, the partner company information table is an information table in which “identification target ID” is associated with “company ID”, “store ID”, and “extraction target information”.

In the partner company information table illustrated in FIG. 6, the identification target IDs “X1” and “X2” are identification target IDs of the respective identification targets 6 provided in the store A₁, and the identification target ID “X3” is the identification target ID of the identification target 6 provided in the store A₂. Further, the store IDs “A1” and “A2” of the stores A₁ and A₂ are associated with the company ID “CA”, and the store IDs “B1” and “B2” of the stores B₁ and B₂ are associated with the company ID “CB”.

For example, when the identification target ID “X1” is included in the detection information, the user information extraction unit 53 determines that the partner company C corresponding to the user entering place has the company ID “CA” and the store ID “A1”.

Further, in the example illustrated in FIG. 6, “partner company” is associated with the store IDs “A1” and “B1”, and “store” is associated with the store ID “A2” and “B2”. The extraction target information “partner company” is a setting that the user information of the partner company C that the entering user U has entered among pieces of the user information of the entering user U is set as an extraction target to be extracted by the user information extraction unit 53. Moreover, the extraction target information “store” is a setting that the user information of the store that the entering user U has entered among pieces of the user information of the entering user U is set as an extraction target to be extracted by the user information extraction unit 53.

The user information extraction unit 53 identifies the user ID (destination user ID) of the partner company C corresponding to the user entering place based on the terminal ID included in the detection information. This identification is made based on an associated information table stored in the associated information DB 42.

FIG. 7 is a diagram illustrating an example of the associated information table. As illustrated in FIG. 7, the associated information table is an information table in which “terminal ID” is associated with “source user ID”, “company ID”, and “destination user ID”.

The “terminal ID” is identification information of the user terminal 5 that has transmitted the detection information and is, e.g., a MAC address of the first wireless communication unit 20 of the user terminal 5 or unique identification information assigned by an application program of the user terminal 5.

The “source user ID” is identification information of the user U set by the service provider and is, e.g., a login ID of a not illustrated site server operated by the service provider. For example, when a terminal ID “Ti” is included in the detection information, the user information extraction unit 53 determines that the destination user ID is “UA1” and “UB1” and that the source user ID is “U1”.

The user information extraction unit 53 extracts the user information corresponding to the terminal ID included in the detection information from among the user information according to the extraction target information. For example, when the identification target ID is associated with extraction target information “partner company”, the user information extraction unit 53 extracts the user information corresponding to the terminal ID from among the user information associated with the company ID corresponding to the identification target ID.

When the identification target ID is associated with extraction target information “store”, the user information extraction unit 53 extracts the user information corresponding to the terminal ID from among the user information associated with the company ID and store ID corresponding to the identification target ID.

When there is no user information corresponding to the terminal ID among the user information associated with the company ID corresponding to the identification target ID, the user information extraction unit 53 can acquire the user information corresponding to the terminal ID from a user information data table stored in the user information DB 43. In the user information data table, the user information is associated with the source user ID. The user information set in the user information data table includes, e.g., the user attribute, behavior history, social graph, and the like, as illustrated in FIG. 5.

4.4 Grouping Processing Unit

The grouping processing unit 54 assigns the user terminal 5 to one or more groups based on the user information extracted by the user information extraction unit 53.

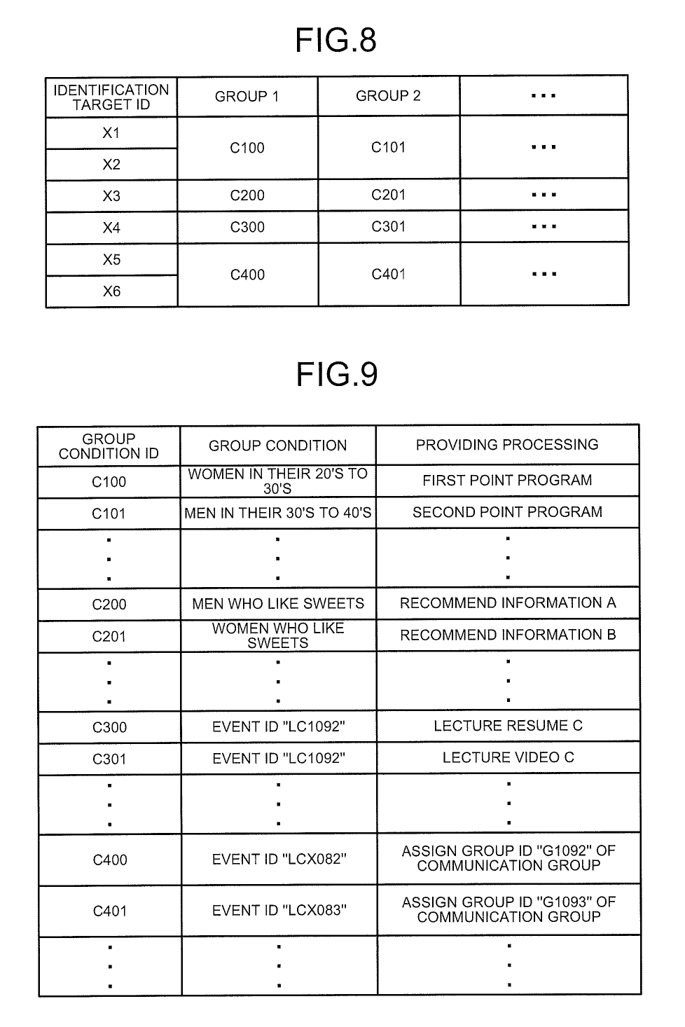

The grouping processing unit 54 assigns the user terminal 5 to one or more groups based on, e.g., a group setting information table stored in the group information DB 44. FIG. 8 is a diagram illustrating an example of the group setting information table.

As illustrated in FIG. 8, the group setting information table is an information table in which “group 1”, “group 2”, . . . are associated with the “identification target ID”. A group condition ID is set for each group. In the example of FIG. 8, group condition IDs “C100” and “C101” are associated with the identification target IDs “X1” and “X2”.

The group condition ID is identification information for identifying a group condition, and the group condition is set in a group condition information table. FIG. 9 is a diagram illustrating an example of the group condition information table. As illustrated in FIG. 9, the group condition information table is an information table in which “group condition” and “providing processing” are associated with the “group condition ID”.

The “group condition” is a condition for assigning the user terminal 5 to the group. A group in which the user information corresponding to the user terminal 5 satisfies the “group condition” is assigned to the user terminal 5. For example, the group condition of a group condition ID “C100” is that the user U of the user terminal 5 is a woman in her 20's to 30's, and group condition of a group condition ID “C200” is that the user U of the user terminal 5 is a man who likes sweets.

Further, for example, the group condition of a group condition ID “C300” is that the user U of the user terminal 5 has applied for an event having an event ID “LC1092”, and group condition of a group condition ID “C401” is that the user U of the user terminal 5 has applied for an event having an event ID “LCX083”. The group condition may be a condition based on the purchase history or behavior history in place of a condition based on the user attribute or whether or not application is made for an event.

The “providing processing” is information indicative of processing content set for the group. The providing processing includes the information providing processing and service providing processing, and is executed by the group control unit 55 as described later.

When the group condition is based on a friendship, the grouping processing unit 54 assigns the user terminal 5 to the group based on the social graph information set in the partner user information table of the partnership information DB 41. The group condition may be based on a relationship between the users U and may thus be based on a business relationship in place of the friendship. Further, the group condition may be based on not only a direct relationship between the users U, but also an indirect relationship between the users U through another user U.

4.5 Group Control Unit

The group control unit 55 executes the providing processing set for each group assigned to the user terminal 5 by the grouping processing unit 54. The providing processing executed by the group control unit 55 includes, e.g., point program application processing, community group formation processing, content transmission processing, recommend information transmission processing, and the like.

The group control unit 55 executes the providing processing set for each group based on the group condition information table. Assume that the group condition information table is in a state illustrated in FIG. 9. In this case, the group control unit 55 assigns the first point program to the entering user U of the user terminal 5 assigned to a group of a group condition ID “C100”. Further, the group control unit 55 assigns the second point program to the entering user U of the user terminal 5 assigned to a group of a group condition ID “C101”.

The first point program is a point program targeting, e.g., women in their 20's to 30's, and the second point program is a point program targeting, e.g., men in their 30's to 40's. This allows a more attractive point program to be provided to the user U.

The point program is a service that provides goods or services according to points that the user U has acquired. The user U acquires the points when he or she visits a store or purchases an article. For example, the group control unit 55 notifies the information management device 4 of the partner company C corresponding to the identification target ID of information of the point program assigned to the entering user U and destination user ID of the entering user U. As a result, in the partner company C, the point program determined by the group control unit 55 is applied to the user U.

The group control unit 55 can give the entering user U the visit points according to the assigned point program and notify the information management device 4 of the partner company C of information of the given points and destination user ID of the entering user U. This can reduce a processing load of the information management device 4.

The group control unit 55 transmits recommend information A to the user terminal 5 assigned to a group of a group condition ID “C200” and transmits recommend information B to the user terminal 5 assigned to a group of a group condition ID “C201”. The recommend information A and B (example of the providing information) are stored in, e.g., the group information DB 44, and the group control unit 55 acquires the recommend information A and B from the group information DB 44.

The recommend information A is information related to, e.g., sweets for men, and recommend information B is information related to, e.g., sweets for women. This allows more adequate recommend information to be provided to the entering user U. The recommend information A and B are transmitted from the information management device 4 to the information processing apparatus 2 and are then stored in the group information DB 44.

For example, the group control unit 55 transmits a lecture resume C to the user terminal 5 assigned to a group of a group condition ID “C300”. The lecture resume C is stored in, e.g., the group information DB 44, and the group control unit 55 acquires the lecture resume C from the group information DB 44 and transmits the acquired lecture resume C to the user terminal 5.

Further, the group control unit 55 transmits a lecture video C to the user terminal 5 assigned to a group of a group condition ID “C301”. The lecture video C is video data (including image data and voice data) acquired in real time by means of a video camera installed in a store that the user U enters.

The group control unit 55 acquires video data from the information management device 4 over the communication network 9 and transmits the acquired video data to the user terminal 5 of the group of the group condition ID “C301” as the lecture video C. The group control unit 55 can acquire the video data from the video camera over the communication network 9.

As described above, when, for example, a user U who has applied for seminar attendance enters a seminar venue, he or she can view the lecture resume C and lecture video C of the seminar on the user terminal 5. This can save time and trouble for a seminar organizer to print or distribute the resume and the like.

The event is not limited to the seminar but may be a marriage meeting, a party, a tour, a golf competition, a concert, and a sports game watching. The group control unit 55 can provide a material of the event or a live video of the event to the user terminal 5 of the user U who has applied for the event.

Further, the group control unit 55 assigns a group ID “G1092” of a communication group to the user terminal 5 assigned to a group of a group condition ID “C400”. Further, the group control unit 55 assigns a group ID “G1093” of a communication group to the user terminal 5 assigned to a group of a group condition ID “C401”.

The group control unit 55 transmits the group ID assigned for each group to the user terminal 5. The control unit 26 of the user terminal 5 acquires the group ID from the information processing apparatus 2 and then exchanges a message within the communication group of the group ID.

The group control unit 55 can form the communication group by notifying the communication server 3 of the group ID and terminal ID assigned to the group in place of transmitting the group ID to the user terminal 5. In this case, the communication server 3 notifies the user terminal 5 of the group ID, thereby allowing the user terminal 5 to exchange a message within the communication group.

The communication group assigned by the group control unit 55 may be a group available only for a predetermined period of time and may be deleted after elapse of the predetermined time period. Further, when the seminar is held several times, the group control unit 55 can cancel participation of the user U in the communication group, whose frequency of participation in the seminar is equal to or less than a predetermined level. In this case, the group control unit 55 notifies the communication server 3 of the terminal ID of the user U whose participation is to be canceled after elapse of a predetermined time period after assignment of the user U to the group.

4.6 Condition Determination Unit

The condition determination unit 56 sets information indicative of the group condition or processing content to be set for the group in the group condition information table of the group information DB 44.

For example, the condition determination unit 56 determines the group condition depending on bids from the bidder terminals 7 and sets the determined group condition in the group condition information table. The group condition may be set for each partner company C or for each store. Further, it is possible to set one group condition for a plurality of partner companies C or for a plurality of stores (in this case, the partner companies C to which the stores belong may not be the same).

The condition determination unit 56 acquires a bid request from each bidder terminal 7 and notifies the bid request to other bidder terminals 7. The bid request includes information of the store or partner company C, information of the group condition, and information of a bid price. The condition determination unit 56 receives the bid requests also from other bidder terminals 7 for the same group condition and regards a bidder who has transmitted the bid request including the highest bid price as a successful bidder. The condition determination unit 56 acquires, from the bidder terminal 7 of the successful bidder, information indicative of the processing content to be set for the group and set the acquired processing content in the group condition information table together with the information of the group condition.

The condition determination unit 56 can receive a request from an external device in such a manner that overlapped group conditions are not set in the group condition information table. Further, in a case where the condition determination unit 56 has acquired the group condition proposed by the partner company C from the information management device 4 and where the group condition has been successfully bid through a bid from the bidder terminal 7, the condition determination unit 56 can set the group condition proposed by the partner company C in the group condition information table.

Some or all of the above-described functions of the control unit 32 may be realized in the user terminal 5. That is, the control unit 26 of the user terminal 5 can execute at least one of the user information acquisition unit 51, the detection information acquisition unit 52, the user information extraction unit 53, the grouping processing unit 54, the group control unit 55, and the condition determination unit 56.

For example, in the user terminal 5, the user information acquisition unit 51 can acquire, from the partnership information DB 41, the user information corresponding to the user terminal 5 and can further store the acquired user information in the storage unit 25. In this case, the storage unit 25 functions as a business operator information database that stores some user information among the user information stored in the partnership information DB 41.

Further, in the user terminal 5, the detection information acquisition unit 52 can acquire the detection information from the information transmission unit 28. In the user terminal 5, the user information extraction unit 53 can refer to the storage unit 25 to extract the user information of a business operator corresponding to the identification target ID included in the detection information acquired by the detection information acquisition unit 52 from among pieces of the user information acquired by the user information acquisition unit 51.

Further, in the user terminal 5, the grouping processing unit 54 can assigns the user terminal 5 to one or more groups based on the user information extracted by the user information extraction unit 53. In the user terminal 5, the group control unit 55 can execute the providing processing set for each group assigned to the user terminal 5 by the grouping processing unit 54.

Further, the condition determination unit 56 can set, in the storage unit 25, the group condition or information indicating the processing content set for the group as a group condition information table based on a request from an external device. The group condition information table is, e.g., the same table as the group condition information table of the group information DB 44.

The control unit 26 of the user terminal 5 can execute some of one or more functions of each of the user information acquisition unit 51, the detection information acquisition unit 52, the user information extraction unit 53, the grouping processing unit 54, the group control unit 55, and the condition determination unit 56.

### 5. PROCESSING OF INFORMATION PROCESSING SYSTEM

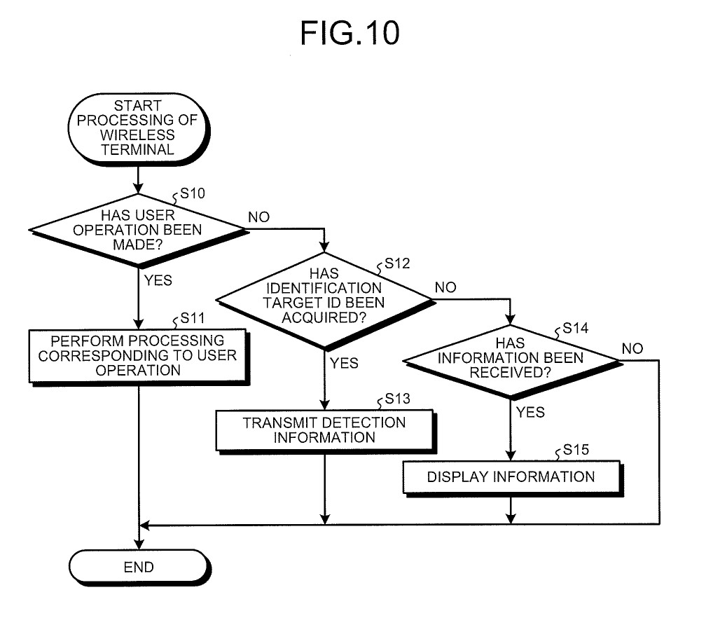

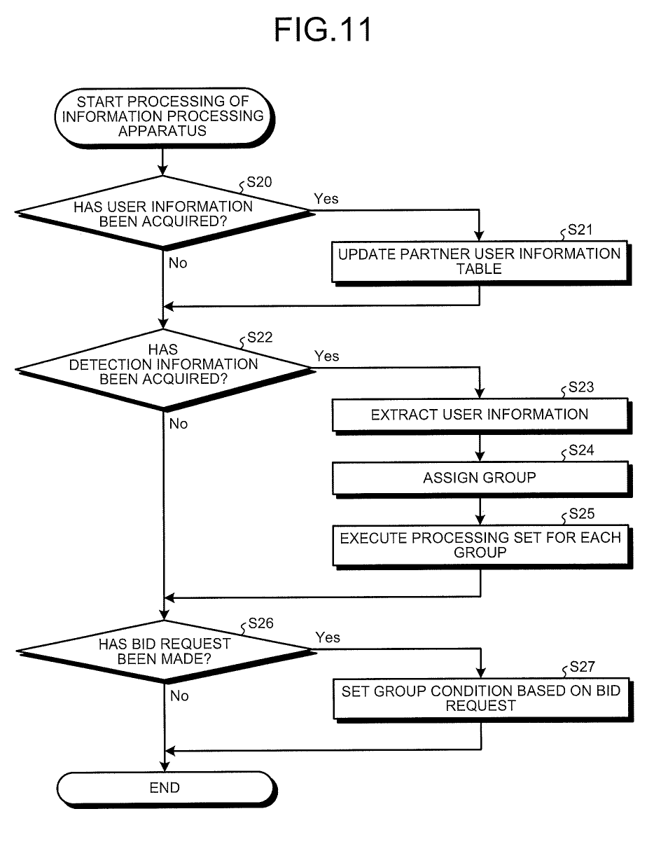

The following describes a procedure of information processing to be performed by the information processing system 1 according to the embodiment. FIGS. 10 and 11 are flowcharts illustrating an information processing flow of the information processing system 1. In the following description, the information processing of the user terminal 5 will be described with reference to FIG. 10, and the information processing of the information processing apparatus 2 will be described with reference to FIG. 11.

5.1 Processing of User Terminal

First, the information processing of the user terminal 5 according to the embodiment will be described. FIG. 10 is a flowchart illustrating an example of the information processing of the user terminal 5 according to the embodiment. The operation is processing repeatedly executed by the control unit 26 of the user terminal 5.

As illustrated in FIG. 10, the control unit 26 of the user terminal 5 determines whether a user operation has been made (step S10). When it is determined that the user operation has been made (Yes in step S10), processing based on the user operation is performed (step S11). For example, the control unit 26 transmits a message input through the user operation to the communication server 3.

When it is determined that the user operation has not been made (No in step S10), the control unit 26 determines whether the identification target ID has been acquired from the identification target 6 (step S12). When it is determined that the identification target ID has been acquired (Yes in step S12), the control unit 26 transmits detection information including the acquired identification target ID and the terminal ID to the information processing apparatus 2 (step S13).

When it is determined that the identification target ID has not been acquired (No in step S12), the control unit 26 determines whether information has been received from the information processing apparatus 2 (step S14). When it is determined that information has been received (Yes in step S14), the control unit 26 displays the received information on the display unit 23 and stores the same in the storage unit 25 (step S15).

When the processing of steps S11, S13, and S15 is ended or when it is determined in step S14 that information has not been received (No in step S14), the control unit 26 ends this routine.

5.2 Processing of Information Processing Apparatus

Next, the information processing of the information processing apparatus 2 will be described. FIG. 11 is a flowchart illustrating information processing of the information processing apparatus 2 according to the embodiment. The operation is processing repeatedly executed by the control unit 32 of the information processing apparatus 2.

As illustrated in FIG. 11, the control unit 32 determines whether the user information of the partner company C has been acquired from the information management device 4 via the communication unit 30 (step S20). When it is determined that the user information of the partner company C has been acquired (Yes in step S20), the control unit 32 sets the acquired user information in the partner user information table of the partnership information DB 41 and updates the partner user information table (step S21).

Subsequently, when it is determined in step S20 that the user information of the partner company C has not been acquired (No in step S20), or when the processing of step S21 is ended, the control unit 32 determines whether the detection information transmitted from the user terminal 5 has been acquired via the communication unit 30 (step S22).

When it is determined that the detection information has been acquired (Yes in step S22), the control unit 32 refers to the partnership information DB 41 to extract the user information corresponding to the user terminal 5 of the entering user U from among pieces of the user information of the partner company C corresponding to the user entering place (step S23). Then, based on the user information extracted in step S23, the control unit 32 assigns the user terminal 5 of the entering user U to one or more groups (step S24). Further, the control unit 32 executes the process set for the assigned group (step S25).

When it is determined that the detection information has not been acquired (No in step S22), or when the processing of step S25 is ended, the control unit 32 determines whether the bid request has been made from the bidder terminal 7 (step S26). When it is determined that the bid request has been made (Yes in step S26), the control unit 32 sets the group condition in the group condition information table based on the bid request (step S27).

When it is determined that the bid request has not been made (No in step S26), or when the processing of step S27 is ended, the control unit 32 ends this routine.

### 6. MODIFICATION

The condition determination unit 56 can receive the bid request when, for example, the group condition designated in the bid request from the bidder terminal 7 is that the bidder is the partner company C or a manufacturer of an article sold by the partner company C.

For example, the bid request that designates the “entering user U who has entered into the store of the partner company CA and found an article A as a favorite one” as the group condition may be received by the condition determination unit 56 when the bidder is the partner company CA or a business operator who provides the article A to the partner company CA.

Further, the condition determination unit 56 can receive the bid request when the bidder is the partner company C that has signed a mutual usage contract. For example, when the partner companies CA and CB have signed a mutual usage contract, associated information is stored in the group information DB 44 as mutual usage information. When the bid request designates the entering user U associated with the partner company CA, for example, the condition determination unit 56 can receive the bid request based on the mutual usage information of the group information DB 44 when the bidder is the partner company CA or the partner company CB only.

Further, the bidder may be limited for each partner company C, for example. For example, when the bidder is manufacturing company A or B, the partner company CA can receive posting information that designates the user U associated with the partner company CA. Bidder limiting information of each partner company C is stored in the group information DB 44. When the bidder is the partner company CA or manufacturing company A or B, for example, the condition determination unit 56 can receive the bid request based on the bidder limiting information of the group information DB 44.

Further, the partner companies C that have signed a mutual usage contract may use the user information. For example, when the partner companies CA and CB have signed a mutual usage contract, the user information extraction unit 53 can extract the user information of the partner company CB based on the mutual usage information of the group information DB 44 when the user information of the partner company CA is not present, for example. Further, even when the user information of the partner company CA is present, the user information extraction unit 53 can extract the user information of the partner company CA and the user information of the partner company CB as one user information.

Further, in the above-described embodiment, the grouping processing unit 54 assigns the user terminal 5 to one or more groups every time the detection information is acquired from the user terminal 5; however, it is possible to inhibit the grouping processing unit 54 from performing the group assignment for the user terminal 5 within a predetermined time period after the previous group assignment. The predetermined time period can be set by the bidder.

Further, the grouping processing unit 54 may be configured to assign the user terminal 5 to one or more groups when the radio wave intensity included in the detection information from the user terminal 5 is equal to or higher than a predetermined value. When there is no group to which the user terminal 5 is assigned, the grouping processing unit 54 can notify one or more bidder terminals 7 of the user information of the user terminal 5 as reference information for setting the group condition.

Thus, it is possible to provide to the bidder the reference information for setting the group condition.

Further, the group control unit 55 can perform the providing processing set for each group assigned to the user terminal 5 at a timing at which the group assignment is performed by the grouping processing unit 54 or at a predetermined timing.

### 7. HARDWARE CONFIGURATION

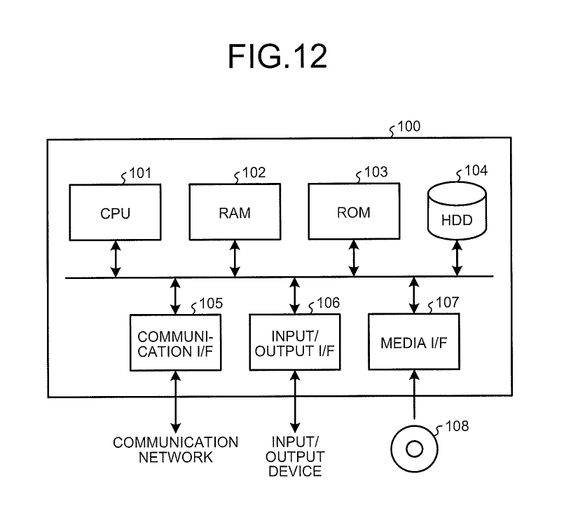

In the embodiment, the information processing apparatus 2 is realized by, e.g., a computer 100 having a configuration as illustrated in FIG. 12. FIG. 12 is a hardware configuration diagram illustrating an example of the computer that realizes functions of the information processing apparatus 2.

The computer 100 includes a CPU (Central Processing Unit) 101, a RAM (Random Access Memory) 102, a ROM (Read Only Memory) 103, an HDD (Hard Disk Drive) 104, a communication interface (I/F) 105, an input/output interface (I/F) 106, and a media interface (I/F) 107.

The CPU 101 operates based on a program stored in the ROM 103 or the HDD 104 and controls respective units. The ROM 103 stores a booting program executed by the CPU 101 during startup of the computer 100, a program dependent on the hardware of the computer 100, and the like.

The HDD 104 stores a program executed by the CPU 101 and data and the like used by the program. The communication interface 105 corresponds to the communication unit 30, receives data from other devices over the communication network 9, transmits the data to the CPU 101, and transmits the data generated by the CPU 101 to other devices over the communication network 9.

The CPU 101 controls an output device such as a display or a printer and an input device such as a keyboard or a mouse via the input/output interface 106. The CPU 101 acquires data from the input device via the input/output interface 106. Further, the CPU 101 outputs the generated data to the output device via the input/output interface 106.

The media interface 107 reads a program or data stored in a recording medium 108 and provides the same to the CPU 101 via the RAM 102. The CPU 101 loads the program from the recording medium 108 onto the RAM 102 via the media interface 107 and executes the loaded program. The recording medium 108 is an optical recording medium such as a DVD (Digital Versatile Disc) or a PD (Phase Change Rewritable Disk), a magneto-optical recording medium such as an MO (Magneto-Optical disk), a tape medium, a magnetic recording medium, or semiconductor memory.

The CPU 101 of the computer 100 executes the program loaded onto the RAM 102 to thereby realize the respective functions of the user information acquisition unit 51, the detection information acquisition unit 52, the user information extraction unit 53, the grouping processing unit 54, the group control unit 55, and the condition determination unit 56. Further, the HDD 104 realizes the respective functions of the partnership information DB 41, the associated information DB 42, the user information DB 43, and the group information DB 44.

The CPU 101 of the computer 100 reads these programs from the recording medium 108 and executes the read programs; alternatively, however, the CPU 101 may acquire these programs from another device over the communication network 9.

### 8. ADVANTAGEOUS EFFECTS

The information processing apparatus 2 according to the embodiment includes a partnership information DB 41 (an example of a business operator information database), a detection information acquisition unit 52 (an example of an information acquisition unit), a user information extraction unit 53, a grouping processing unit 54, and a group control unit 55. The detection information acquisition unit 52 acquires information on an identification target 6 from a user terminal 5 that detects the information on the identification target 6 provided in a place corresponding to a partner company C (an example of a business operator). The user information extraction unit 53 refers to the partnership information DB 41, when the information on the identification target 6 has been acquired by the detection information acquisition unit 52, to extract the user information corresponding to the user terminal 5 that has transmitted the detection information from among pieces of the user information of the partner company C corresponding to the place in which the identification target 6 is provided. The grouping processing unit 54 assigns the user terminal 5 to one or more groups based on the user information extracted by the user information extraction unit 53.

With this configuration, it is possible to assign the user terminal 5 to an adequate group according to the user entering place based on the user information corresponding to the entering user U, thus making it possible to provide adequate services or information according to the user entering place.

Further, the group control unit 55 executes the process set for each the group assigned to the user terminal 5 by the grouping processing unit 54.

With this configuration, it is possible to provide adequate services or information according to the user entering place based on the user information corresponding to the entering user U.

Further, the information processing apparatus 2 according to the embodiment includes the group information DB 44 (an example of a providing information storage unit) that stores information of the group and providing information in association with each other. The group control unit 55 extracts the providing information according to the group assigned by the grouping processing unit 54 from the group information DB 44 and distributes the extracted providing information to the user terminal 5 that detects the information on the identification target 6.

With this configuration, the information processing apparatus 2 can provide services or information not only according to a place corresponding to the business operator, but also according to the user information. Thus, it is possible to provide information according to the group that is assigned, based on the user information, to the user U that has entered the place corresponding to the business operator.

Further, the group control unit 55 assigns the group ID according to the group assigned by the grouping processing unit 54 to the user terminal 5 that detects the information on the identification target 6.

With this configuration, the group ID according to the group assigned by the grouping processing unit 54 is assigned to the user terminal 5, thereby allowing various services using the group ID to be provided. For example, the assigned group ID can be used for grouping event participants at the user entering place.

The group ID is the identification information of the community group where a message is exchanged between the user terminals 5. The user terminal 5 exchanges the message based on the group ID.

With this configuration, simply by entering the place where the identification information on the identification target 6 is provided, the entering user U can participate in the network community formed among the user terminals 5 of the users U having the same user information. Thus, for example, an event participant can easily participate in the community simply by entering an event site to thereby get a chance of new communication.

Further, the partnership information DB 41 stores, as the user information, the attribute information of the user U having the user terminal 5. The grouping processing unit 54 assigns the user terminal 5 to one or more groups based on the attribute information of the user U.

With this configuration, it is possible to assign a group where the user attribute included in the user information corresponding to the user terminal 5 is the same among members to the user terminal 5, allowing grouping according to the user attribute to be made.

Further, the partnership information DB 41 stores event application information as the user information. The grouping processing unit 54 assigns the user terminal 5 to one or more groups based on the event application information.

With this configuration, it is possible to distribute, e.g., content according to the group to the user terminal 5 of the entering user U. Thus, when the entering place of the user U is, e.g., a private tutoring school or a seminar venue, the control unit 32 distributes, to the user terminal 5 of the entering user U, e.g., a resume of a lecture or other materials.

Further, the partnership information database 41 stores information indicating a relationship between the users U having their respective user terminals 5 as the user information. The grouping processing unit 54 assigns the user terminal 5 to one or more groups based on the relationship between the users U.

With this configuration, it is possible to easily form a community based on an acquaintance relationship between the users U participating in the same event, thereby providing a chance of new communication.

Further, the information processing apparatus 2 according to the embodiment includes the condition determination unit 56 that determines a group assignment condition depending on bids.

With this configuration, it is possible to easily and effectively sale the group condition, thus making it possible to effectively expand services provided by the information processing apparatus 2.

### 9. OTHERS

Some embodiments of the present invention have been described in detail with reference to the drawings. The embodiments are illustrative, and various modifications and changes of the invention including the aspects described in the Detailed Description of the Embodiments can be made based on knowledge of those skilled in the art.

The information processing apparatus 2 and communication server 3 described above may be implemented by one server computer. Further, the information processing apparatus 2 or communication server 3 may be implemented by a plurality of server computers. In addition, the structure of the devices may be flexibly changed depending on the functions. For example, an external platform may be called by an API (Application Programming Interface) or network computing and then executed to implement the devices.

According to one aspect of the embodiment, there can be provided an information processing apparatus, an information processing method, and an information processing program capable of performing adequate control according to a place corresponding to a business operator and user information corresponding to a user terminal.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus comprising:
a business operator information database configured to store pieces of user information of a business operator;
an information acquisition unit configured to acquire information on an identification target provided in a place corresponding to the business operator from a user terminal that detects the information on the identification target;
a user information extraction unit configured to, when the information on the identification target is acquired by the information acquisition unit, extract from the business operator information database user information corresponding to the user terminal among the pieces of user information of the business operator corresponding to the place in which the identification target is provided; and
a grouping processing unit configured to assign the user terminal to one or more groups based on the user information extracted by the user information extraction unit.

2. The information processing apparatus according to claim 1, further comprising a group control unit configured to execute a process that is set for each the group assigned to the user terminal by the grouping processing unit.

3. The information processing apparatus according to claim 2, further comprising a providing information storage unit configured to store information on the group and providing information in association with each other, wherein
the group control unit extracts providing information corresponding to the group assigned by the grouping processing unit from the providing information storage unit, and distributes the extracted providing information to the user terminal that detects the information on the identification target.

4. The information processing apparatus according to claim 2, wherein
the group control unit assigns a group ID corresponding to each the group assigned by the grouping processing unit to the user terminal that detects the information on the identification target.

5. The information processing apparatus according to claim 4, wherein
the group ID is identification information on a community group where a message is exchanged between user terminals, and
each the user terminal transmits and receives the message based on the group ID.

6. The information processing apparatus according to claim 1, wherein
the business operator information database stores, as the user information, attribute information on a user having the user terminal, and
the grouping processing unit assigns the user terminal to one or more groups based on the attribute information on the user.

7. The information processing apparatus according to claim 1, wherein
the business operator information database stores, as the user information, behavior history information on a user having the user terminal, and
the grouping processing unit assigns the user terminal to one or more groups based on the behavior history information.

8. The information processing apparatus according to claim 1, wherein
the business operator information database stores, as the user information, information indicative of a relationship between users having respective user terminals, and
the grouping processing unit assigns the user terminals to one or more groups based on the relationship between the users.

9. The information processing apparatus according to claim 1, further comprising a condition determination unit configured to determine a group assignment condition depending on bids.

10. An information processing method executed by a computer, comprising:
acquiring information on an identification target provided in a place corresponding to a business operator from a user terminal that detects the information on the identification target;
extracting, when the information on the identification target is acquired, user information corresponding to the user terminal among pieces of user information of the business operator corresponding to the place, in which the identification target is provided, from a business operator information database that stores the pieces of user information of the business operator; and
assigning the user terminal to one or more groups based on the extracted user information.

11. A non-transitory computer readable storage medium containing program instructions for processing information, wherein execution of the program instructions by one or more processors of a computer system causes the one or more processors to perform:
acquiring information on an identification target provided in a place corresponding to a business operator from a user terminal that detects the information on the identification target;
extracting, when the information on the identification target is acquired, user information corresponding to the user terminal among pieces of user information of the business operator corresponding to the place, in which the identification target is provided, from a business operator information database that stores the pieces of user information of the business operator; and
assigning the user terminal to one or more groups based on the extracted user information.
